(19) United States
(12) Patent Application Publication
(10) Pub. No.: US 2023/0130900 A1
(43) Pub. Date: Apr. 27, 2023

(54) VIRTUAL CLASSROOM WITH REMOTE CLASS FEATURES

(71) Applicant: Class Technologies Inc., Washington, DC (US)

(72) Inventors: Michael L. Chasen, Austin, TX (US); Wesley A. Boyer, Austin, TX (US)

(21) Appl. No.: 17/750,167

(22) Filed: May 20, 2022

Related U.S. Application Data
(60) Provisional application No. 63/271,047, filed on Oct. 22, 2021.

(51) Int. Cl. G09B 5/14; G09B 5/10; G09B 5/06

(52) U.S. Cl. CPC G09B 5/14; G09B 5/10; G09B 5/065

(57) ABSTRACT

A method to provide a remote classroom experience is provided. The method includes providing, to a first client device, a video feed of a virtual classroom, the video feed including a first breakout group with at least one student, receiving, from the first client device, a selection of a first breakout group and a teaching material, providing, to a second client device with the at least one student, a partial video feed of the virtual classroom including other student members of the first breakout group, providing the teaching material to the second client device based on the selection, receiving a feedback from the second client device, responsive to the teaching material, and providing the feedback from the second client device to the first client device. A system and a non-transitory, computer-readable medium storing instructions to perform the above method are also provided.

### CROSS-REFERENCE TO RELATED APPLICATIONS

The present application is related and claims priority under 35 U.S.C. 119(e) to U.S. provisional patent application 63/271,047, entitled REMOTE CLASS FEATURES, to Michael L. Chasen et al., and filed on Oct. 22, 2021, the contents of which are hereby incorporated in their entirety, for all purposes.

### BACKGROUND

### Field

The present disclosure relates to platforms for synchronous group meetings with enhanced learning tools for real-time participant interactions and feedback. More specifically, methods and systems as disclosed herein provide a virtual classroom where instructors or teachers and students may have an improved learning experience, including one-on-one interactions and multimedia access.

### Description of Related Art

Current trends in the industry point to the extended use of meeting platforms for remote access to multiple attendees, including video capabilities, chat options, interpersonal messaging, and other synchronous activities during a scheduled meeting. However, a classroom configuration puts stringent demands on the context of a typical group meeting, which lack the learning and audience monitoring tools that are desirable in an educational environment. Many computerized network systems have been developed to enhance, and in some instances support, the educational experience. However, most of the existing solutions operate in an asynchronous manner, essentially working as intelligent databases for assignment preparation, grading, and statistical analysis over a large student population and a complex scholar curriculum. However, no commercial system available today is capable of combining the synchronous capabilities of a remote group meeting platform with network-based, computerized educational tools.

### SUMMARY

In a first embodiment, a computer-implemented method includes providing, to a first client device, a video feed of a virtual classroom, the video feed including a first breakout group with at least one student. The computer-implemented method also includes receiving, from the first client device, a selection of a first breakout group and a teaching material, providing, to a second client device with the at least one student, a partial video feed of the virtual classroom including other student members of the first breakout group, and providing the teaching material to the second client device based on the selection. The computer-implemented method also includes receiving a feedback from the second client device, responsive to the teaching material, and providing the feedback from the second client device to the first client device.

In a second embodiment, a computer-implemented method includes separating multiple students in a virtual class feed into one or more breakout groups. The computer-implemented method also includes accessing a tab for one of the breakout groups on a display that includes each of the one or more breakout groups, the tab including the students in each of the one or more breakout groups, and providing a teaching assignment to a first breakout group. The computer-implemented method also includes identifying an activity of a student in the first breakout group, accessing the virtual class feed for a second one of the breakout groups for an intervention, based on the activity of the student, and interacting with the student in the first breakout group based on the teaching assignment and the activity of the student.

In a third embodiment, a system includes one or more processors and a memory storing instructions. When executed by the one or more processors, the instructions cause the system to provide, to a first client device, a video feed of a virtual classroom, the video feed including a first breakout group with at least one student, to receive, from the first client device, a selection of a first breakout group and a teaching material, to provide, to a second client device with the at least one student, a partial video feed of the virtual classroom including other student members of the first breakout group, to provide the teaching material to the second client device, to receive a feedback from the second client device, responsive to the teaching material, and to provide the feedback from the second client device to the first client device.

In another embodiment, a system includes a first means to store instructions and a second means to execute the instructions and cause the system to perform a method. The method includes providing, to a first client device, a video feed of a virtual classroom, the video feed including a first breakout group with at least one student. The method also includes receiving, from the first client device, a selection of a first breakout group and a teaching material, and providing, to a second client device with the at least one student, a partial video feed of the virtual classroom including other student members of the first breakout group. The method also includes providing the teaching material to the second client device based on the selection, receiving a feedback from the second client device, responsive to the teaching material, and providing the feedback from the second client device to the first client device.

In yet another embodiment, a non-transitory, computer-readable medium stores instructions which, when executed by a processor, cause the processor to perform a method. The method includes providing, to a first client device, a video feed of a virtual classroom, the video feed including a first breakout group with at least one student. The method also includes receiving, from the first client device, a selection of a first breakout group and a teaching material, and providing, to a second client device with the at least one student, a partial video feed of the virtual classroom including other student members of the first breakout group. The method also includes providing the teaching material to the second client device based on the selection, receiving a feedback from the second client device, responsive to the teaching material, and providing the feedback from the second client device to the first client device.

### BRIEF DESCRIPTION OF THE DRAWINGS

FIG. 1 illustrates an architecture in a system for providing a classroom experience in a group meeting platform, according to some embodiments.

FIG. 2 illustrates details of exemplary devices used in one embodiment of the architecture of FIG. 1, according to some embodiments.

FIGS. 3A-3B illustrate breakout group views in a classroom engine, according to some embodiments.

FIG. 4 illustrates an action sorting feature in a class management tool for a virtual classroom, according to some embodiments.

FIG. 5 illustrates a launch widget within an assessment feature in a teaching tool for a virtual classroom, according to some embodiments.

FIG. 6 illustrates a filtering feature for users and video feeds in a participant tool for a virtual classroom, according to some embodiments.

FIG. 7 illustrates a hybrid learning feature in a teaching tool for a virtual classroom, according to some embodiments.

FIG. 8 illustrates bubble features used in a chat tool for a virtual classroom, according to some embodiments.

FIG. 9 is a flow chart illustrating steps in a method for managing a virtual classroom, according to some embodiments.

FIG. 10 is a flow chart illustrating steps in a method for managing a course for remote learning, according to some embodiments.

FIG. 11 is a block diagram illustrating an example computer system with which the client and server of FIGS. 1 and 2 and the methods of FIGS. 9 and 10 can be implemented, according to some embodiments.

In the figures, elements having the same or similar reference numerals correspond to features having the same or similar description, unless stated otherwise.

### DETAILED DESCRIPTION

In the following detailed description, numerous specific details are set forth to provide a full understanding of the present disclosure. It will be apparent, however, to one ordinarily skilled in the art, that embodiments of the present disclosure may be practiced without some of these specific details. In other instances, well-known structures and techniques have not been shown in detail so as not to obscure the disclosure.

### General Overview

The present disclosure provides an environment and a network architecture that enables the use of a remote group meeting platform for implementing a virtual classroom having enhanced educational capabilities including teaching and learning tools. In addition, in some embodiments, the capabilities of the remote group meeting platform are enhanced to provide student engagement functionalities and classroom management features. Further, some embodiments also include the ability for the instructor and/or a teaching assistant to track, in real time, student attendance and participation for each of the registered and attending students. Some embodiments include a proctoring tool for assignments and exams, allowing the instructor to safely conduct grading and evaluation processes remotely.

Embodiments as disclosed herein provide a technical solution for the technical problem of conducting a synchronous teaching event for multiple remote users, including individualized learning tools and tracking of in-class performance. More generally, embodiments as disclosed herein may in fact replace the more traditional teaching experience by using computer and computer network capabilities to provide new and refined learning tools, such as instant polling and pop quizzes, and incentivizing participation for lagging or disengaged individuals.

The present disclosure further improves the functioning of a computer and a computer network by allocating bandwidth and computational resources judiciously so that a synchronous teaching event (e.g., a class) occurs without interruption and without crashing the network or any one of the client devices used by the students and instructors to access the teaching event.

### Example System Architecture

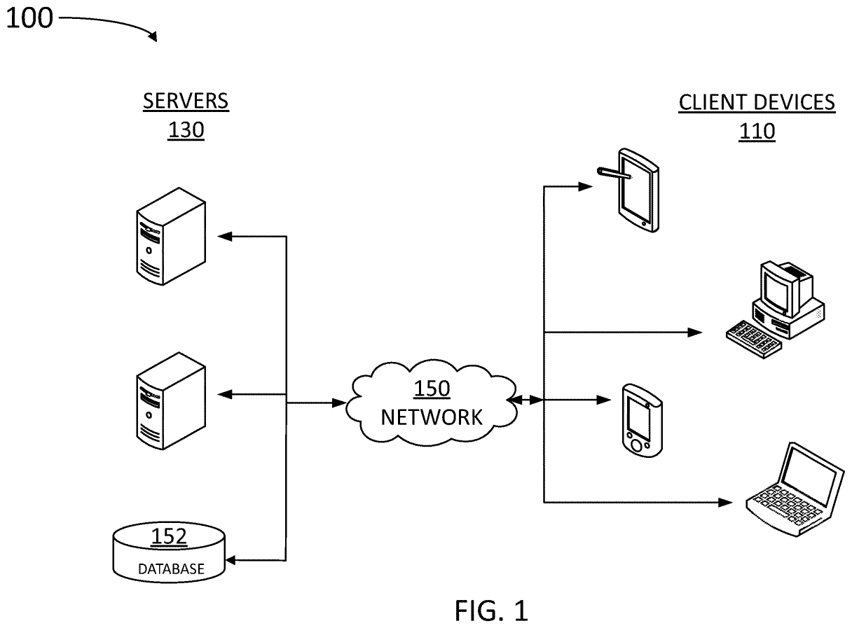

FIG. 1 illustrates an architecture 100 in a system for providing a classroom experience in a group meeting platform, according to some embodiments. Architecture 100 includes servers 130 and client devices 110 coupled over a network 150. Client devices 110 may be used by participants in the classroom experience. In some embodiments, one or more of the participants includes an instructor or a teaching assistant having certain privileges for accessing class materials and feeds from the other participants in the classroom experience. In some embodiments, at least one or more participants are students registered for the class.

One of servers 130 may be configured to host a memory, including instructions which, when executed by a processor, cause the server to perform at least some of the steps in methods as disclosed herein. In some embodiments, the memory may include a database 152 external to, and coupled with, servers 130 through network 150. In some embodiments, the architecture provides personalized digital learning tools to each of a group of participants, who may be the users of the client device communicatively coupled with the network. The targeted digital learning tool may be retrieved from a database, and may be selected by at least one of the participants in the classroom experience (e.g., an instructor or an instructor assistant).

Servers 130 may include any device having an appropriate processor, memory, and communications capability for hosting a database and a classroom engine or a course engine. The classroom engine and the course engine may be accessible by various client devices 110 over network 150. In some embodiments, servers 130 may include a dynamic creative rendering server, a publisher, or a course management system. Client devices 110 may include, for example, desktop computers, mobile computers, tablet computers (e.g., including e-book readers), mobile devices (e.g., a smartphone or PDA), or any other devices having appropriate processor, memory, and communications capabilities for accessing the image search engine and the history log on one or more of the servers. Network 150 can include, for example, any one or more of a local area network (LAN), a wide area network (WAN), the Internet, and the like. Further, network 150 can include, but is not limited to, any one or more of the following network topologies, including a bus network, a star network, a ring network, a mesh network, a star-bus network, a tree or hierarchical network, and the like.

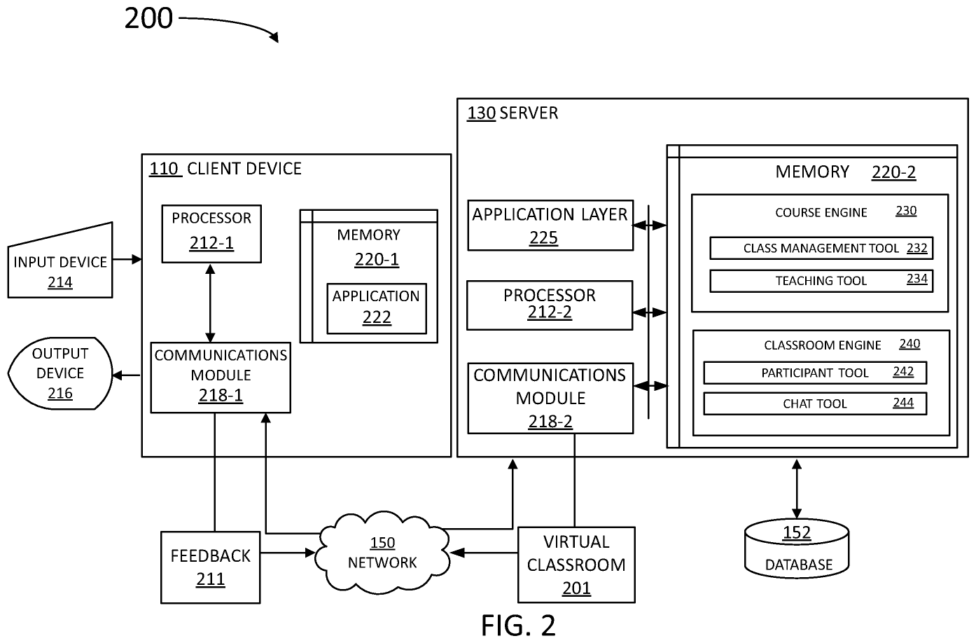

FIG. 2 illustrates details of exemplary devices used in one embodiment of architecture 200 (cf. architecture 100), according to some embodiments. Client device 110 may include a processor 212-1 and a memory 220-1, and server 130 may include a processor 212-2 and a memory 220-2. Hereinafter, processors 212-1 and 212-2 will be collectively referred to as “processors 212,” and memories 220-1 and 220-2 will be collectively referred to as “memories 220.” Client device 110, server 130, and database 152 are communicatively coupled over network 150 via respective communications modules 218-1 and 218-2 (hereinafter, collectively referred to as “communication modules 218”). Communications modules 218 interface with network 150 to send and receive information, such as data, requests, responses, and commands to other devices on network 150. For example, client device 110 may provide a feedback 211 from an instructor or teaching assistant to a student in a virtual classroom 201, which in turn is provided from server 130 to a student or instructor using client device 110. Communications modules 218 can be, for example, modems or Ethernet cards. Client device 110 may be coupled with an input device 214 and with an output device 216. Input device 214 may include a keyboard, a mouse, a pointer, a touch-screen display or a camera configured to collect a video feed from the user (e.g., a participant in the virtual class such as an instructor, a teaching assistant, or a student) that may be utilized to interact with client device 110. Likewise, output device 216 may include a display and a speaker with which the user may retrieve results from client device 110. In this regard, client device 110 may be a smartphone, a virtual reality headset or other mobile device used by a participant at the time of the group meeting. In some embodiments, client device 110 may include a computer or any other network connected device. The participant in the group meeting may be a professor, an instructor, a teaching assistant, or any combination of the above, or one or more students. In some embodiments, the group meeting takes place with a selected frequency on a scheduled basis. In this regard, one or more of the participants may access the group meeting using different client devices 110 on different occasions.

In some embodiments, processor 212-1 executes instructions stored in a memory 220-1, and to cause client device 110 to perform at least some of the steps in methods consistent with the present disclosure. Memory 220-1 may further include an application 222 including specific instructions which, when executed by processor 212-1, cause a teaching tool 234 to display learning materials for the participant through virtual class room 201, or a participant feedback 211 to be displayed to an instructor or teaching assistant also participating in the classroom experience. In some embodiments, feedback 211 may include a video of the user (e.g., instructor, teaching assistant or student) that is compactified and fed into a video feed of virtual classroom 201. Application 222 may be installed by and perform scripts and other routines provided through an application layer 225 in server 130. Application layer 225 produces the output of a classroom engine 240 in the form of virtual classroom 201 or “feed.” Virtual classroom 201 includes learning materials such as quizzes, tests, virtual handouts, poll questions, and multimedia files (e.g., audio, video, and the like). In some embodiments, the learning materials may include visual representations and graphics for the instructor or teaching assistants, indicating test results, poll results, and the like. Accordingly, in some embodiments, the output from application layer 225 includes a graphics bundle illustrating a statistical analysis, charts, and an explanation of student engagement for each of the students attending the class. In some embodiments, application layer 225 collects compacted video files (e.g., feedback 211) from each participant and updates a video feed for virtual classroom 201 every few seconds (1 or 2 seconds) or so, to create a real-time environment.

In some embodiments, a participant having a valid student identification may download application 222 from a school website, or directly from server 130. The learning materials may include multiple digital learning tools presented to the participant by server 130, and the participant may store at least some of the digital learning tools in memory 220-1. In some embodiments, application 222 includes instructions which, when executed by processor 212-1, cause a display in output device 216 to display a portal of classroom engine 240. Accordingly, the application may include instructions, which when executed by the processor in the client device, cause a display in the client device to display a personalized learning material (e.g., quiz, test, question, poll question, white paper, and the like). Moreover, in some embodiments, application 222 may include instructions which, when executed by processor 212-1, cause client device 110 to store feedback 211 in memory 220-1, or in database 152 (e.g., a completed or partially completed test, a graded or partially graded test, and the like).

Server 130 includes a memory 220-2, a processor 212-2, and a communications module 218-2. Processor 212-2 executes instructions, such as instructions physically coded into the processor, instructions received from software in memory 220-2, or a combination of both. Memory 220-2 includes a course engine 230 and classroom engine 240 to prepare and provide learning materials and other classroom support for participants in virtual classroom 201. In some embodiments, classroom engine 240 is also configured to receive, from one or more of the participants, feedback 211, in response to the learning materials in virtual classroom 201. Classroom engine 240 may provide feedback 211 to course engine 230. For example, in some embodiments, classroom engine 240 receives a filled test or quiz from each of the participants. Classroom engine 240 evaluates feedback 211 from the participants (e.g., grade the tests and quizzes, or respond to queries, questions, and requests for learning materials). Classroom engine 240 may include participant tool 242, and chat tool 244.

In some embodiments, course engine 230 includes a class management tool 232 and a teaching tool 234. Class management tool 232 may include templates for preparing teaching materials such as a syllabus, assignments, class assessments (e.g., quizzes and tests) and other tools such as polls, learning management systems, and the like. Class management tool 232 may be accessed by instructors and/or teaching assistants to prepare, modify, and/or update course materials. Teaching tool 234 incorporates learning materials and tools into virtual classroom 201 for an online chat environment. In some embodiments, teaching tool 234 pushes assignments and tests/quizzes to one or more selected students (or to all students in virtual classroom 201) via application layer 225. The assignments may automatically pop up on the screen of output device 216.

A classroom engine 240 may include a participant tool 242 and a chat tool 244. Participant tool 242 keeps a list of known students in the class. In some embodiments, participant tool 242 compares a list of attendees to a list of known students in the class and prepares a list of the students that are absent. In some embodiments, the list of students that are absent may be displayed to the instructor or one of the teaching assistants, via application layer 225. In some embodiments, participant tool 242 keeps track and reports (e.g., to the instructor or one of the teaching assistants) how long someone speaks in a meeting and if it is below average, average, or above average. In some embodiments, participant tool 242 evaluates an engagement level for each of the students in the class, based on the tracking data collected from the students. Accordingly, the instructor or at least one of the teaching assistants may have visibility to an engagement report illustrating the engagement level for each of the students, pushed through application layer 225. In some embodiments, participant tool 242 may push an alert to the instructor or a teaching assistant when a student makes another window on their computer screen (e.g., the class meeting is moved to the background or is not the primary focus of the student on client device 110). Participant tool 242 may also perform attendance tracking and reporting. In some embodiments, participant tool 242 reports when someone attends the class meeting, when someone enters the class meeting and what time they leave, shows amount of participation time, and focus time during which application 222 is the main focus on client device 110.

Chat tool 244 provides real-time evaluation of the learning materials provided to the students, based on the feedback received. Chat tool 244 provides multimedia files (e.g., video, audio, virtual reality feeds) to be included as the learning materials. In some embodiments, chat tool 244 retrieves one or more multimedia files from the database or through a third-party server in the network. In that regard, chat tool 244 may also embed a link to a network address (e.g., an http address or universal resource location—URL) for a file or a feed in the learning materials provided to the students. Accordingly, in some embodiments, each of the participants may access one or more of the learning materials through a browser (e.g., application 222) installed in client device 110. In some embodiments, chat tool 244 may access the network location directly and downstream a multimedia file from the network location into the feed to the participants (e.g., in virtual classroom 201), as part of the learning materials.

In one or more implementations, database 152 may include a list of frequent participants to the group meetings (e.g., student IDs and the like). The participants may have a valid student identification associated with a class, an instructor, or an academic institution. Server 130 may create, update, and maintain database 152, including valid student identifications and academic performance history logs. In that regard, database 152 may be hosted by the academic institution, while classroom engine 240 may be hosted by a DSP server or a dynamic creative rendering server. Accordingly, a DSP server 130 may have access to one or more databases 152, through agreements with one or more academic institutions. In certain aspects, a processor 212-2 hosted by an academic institution accesses and stores data in the database such as valid student identification used at prior class meetings, over a pre-selected span of time.

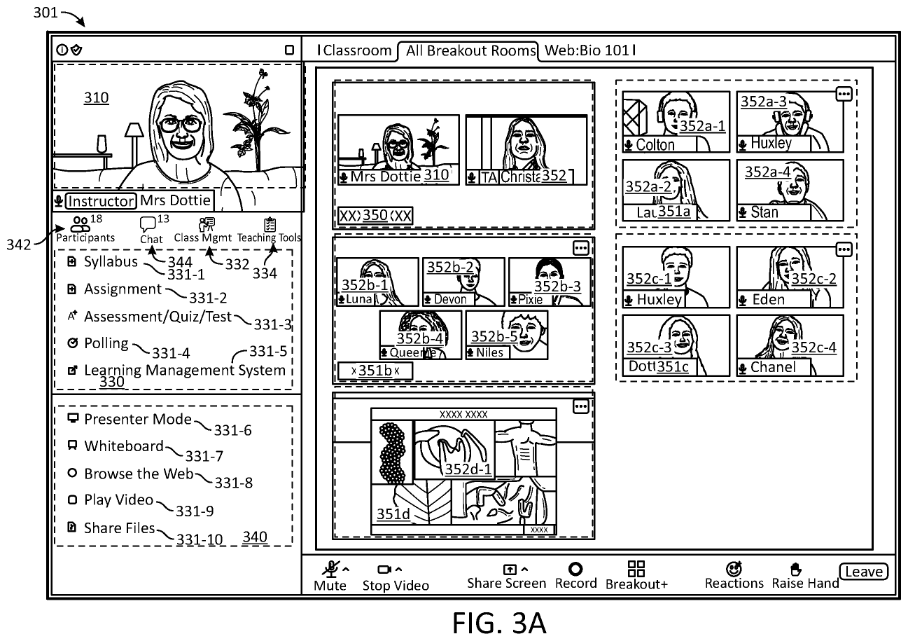

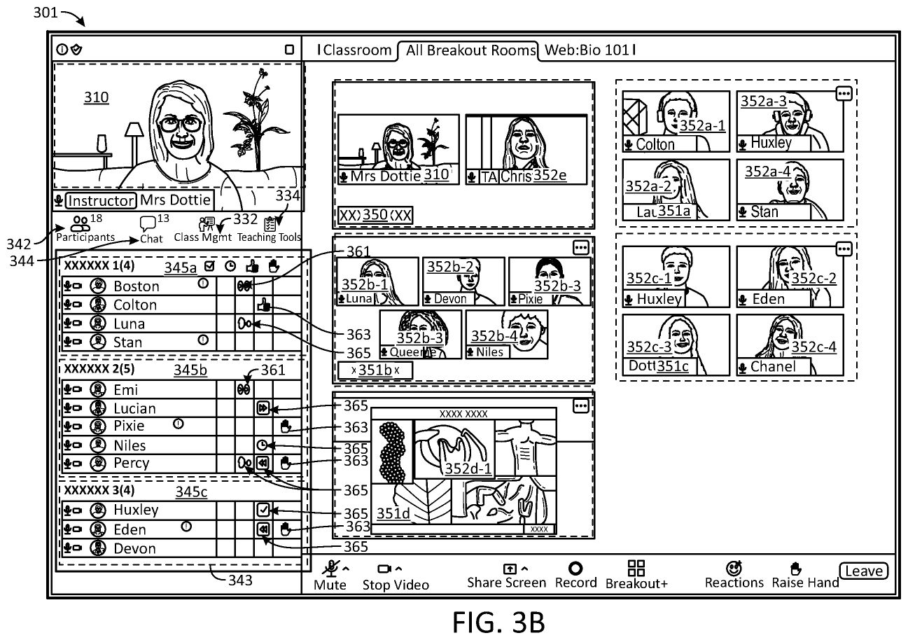

FIGS. 3A-3B illustrate breakout group views 351a, 351b, 351c, and 351d (hereinafter, collectively referred to as “breakout groups 351”) in a virtual classroom 301, according to some embodiments. Virtual classroom 301 includes a video feed of the instructor 310 in a virtual podium. In some embodiments, the virtual podium stays in the same position during the class. In some embodiments, a guest lecturer, or a presenter, can be moved temporarily to the virtual podium and replace, albeit temporarily, instructor 310. Virtual classroom 301 may include a view of main classroom 350, including the instructor in virtual podium 310 and at least one student view 352. Breakout group view 351a includes students 352a-1, 352a-2, 352a-3, and 352a-4. Breakout group view 351b includes students 352b-1, 352b-2, 352b-3, 352b-4, and 352b-4. Breakout group view 351c includes students 352c-1, 352c-2, 352c-3, and 352c-4 (collectively referred to, hereinafter, as “students 352”). And breakout group view 351d includes panel 352d-1.

In some embodiments, when students 352 or instructor 310 go into breakout rooms 351, video and audio is turned on, but when back to main classroom 350, video and audio go back to previous status. Instructor 310 is able to see all of breakout groups 351 simultaneously, with each of student groups 352a, 352b, 352c, and even any student (e.g., student 352e) who may be left without a group in the main classroom 350.

In addition, virtual classroom 301 includes a class management tool 332, and a teaching tool 334, as part of a course engine 330, and a participant tool 342, and a chat tool 344 as part of a classroom engine 340. Course engine 330 may include a syllabus feature 331-1, an assignment feature 331-2, an assessment/quiz/test feature 331-3, a polling feature 331-4, and a learning and management system feature 331-5. Classroom engine 340 may include a presenter mode feature 331-6, a whiteboard feature 331-7, a browsing feature 331-8, a multimedia feature 331-9, and a file sharing feature 331-10.

Participants tool 342 may include a panel 343 listing different attributes 345a for each of students 352a in breakout group 351a. Panel 343 also lists attributes 345b for each of students 352b in breakout group 351b, and attributes 345c for each of students 352c in breakout group 351c. Some of attributes 345a, 345b, and 345c may indicate visually, to instructor 310, the type of activity that is happening in each of breakout groups 351, and how each of students 352 is participating in the activity. To aid in this, panel 343 may include icons such as an attention warning 361 indicating that certain students 352 are not paying attention, a gesture icon 363 indicating a student “like” or that a student has raised a hand, or a participation icon 365 indicative that a student 352 has spoken, recorded, or chatted with its breakout group 351.

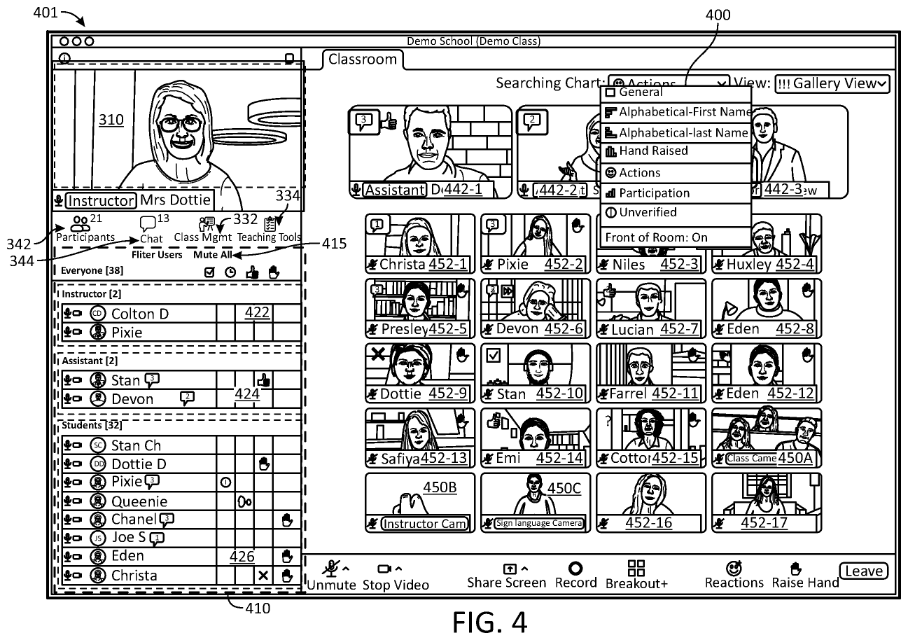

FIG. 4 illustrates an action sorting feature 400 in a class management tool 332 for a virtual classroom 401, according to some embodiments. Virtual classroom 401 displays teaching assistants 442-1, 442-2, and 442-3 (hereinafter, collectively referred to as “teaching assistants 442”), and students 452-1, 452-2, 452-3, 452-4, 452-5, 452-6, 452-7, 452-8, 452-9, 452-10, 452-11, 452-12, 452-13, 452-14, 452-15, 452-16, and 452-17 (hereinafter, collectively referred to as “students 452”). In some embodiments, virtual classroom 401 may also include video feeds from a class camera 450A (taking a shot at some audience in a real/virtual classroom), from an instructor camera 450B (taking a shot from the instructor's notes, whiteboard, or blackboard), and from a sign language camera 450C (taking a shot at a sign language translator for auditive impaired people). Hereinafter, video feeds 450a, 450B and 450C will be collectively referred to as “auxiliary feeds 450.”

In some embodiments, sorting feature 400 is configured to automatically arrange video feeds for students 452 according to different, selectable criteria. The selectable criteria may include alphabetical order (by first name or last name), or an action taken by students 452. For example, sorting tool 400 may move the students that are raising their hand, sending a message, or giving feedback, to the front of the video feed so the instructor can easily see who needs to be responded to.

A participation list 410 includes attributes for each of the instructors 422, teaching assistants 424, and students 426. A mute feature 415 enables instructor 310 and/or a suitably authorized individual to mute one or more students 452 that are attending in-person.

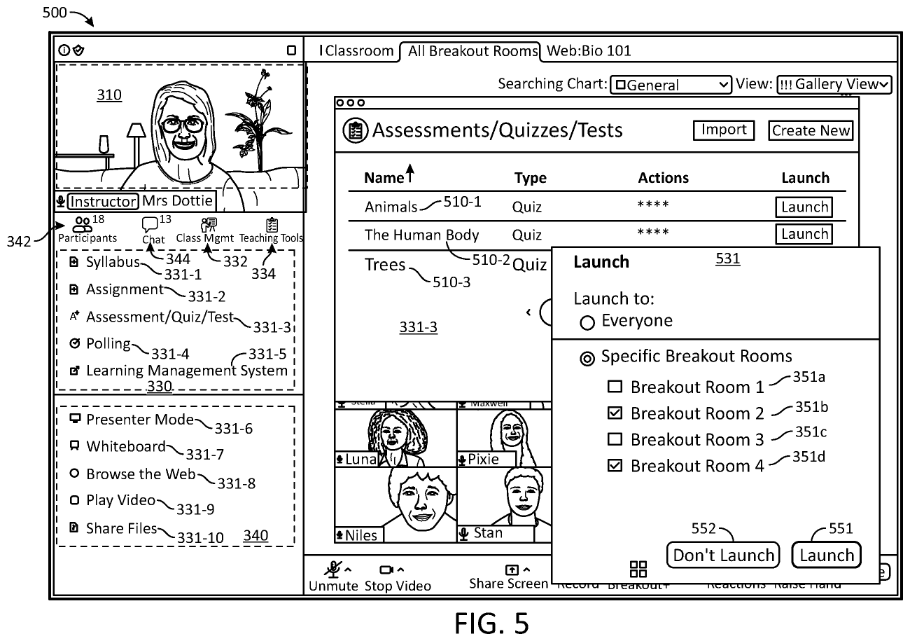

FIG. 5 illustrates a launch widget 531 within assessment feature 331-3 in a teaching tool 334 for a virtual classroom 501, according to some embodiments. In addition, virtual classroom 501 includes a class management tool 332, as part of a course engine 330, and a participant tool 342, and a chat tool 344 as part of a classroom engine 340. Course engine 330 may include a syllabus feature 331-1, an assignment feature 331-2, an assessment/quiz/test feature 331-3, a polling feature 331-4, and a learning and management system feature 331-5. Classroom engine 340 may include a presenter mode feature 331-6, a whiteboard feature 331-7, a browsing feature 331-8, a multimedia feature 331-9, and a file sharing feature 331-10.

Launch widget 531 enables instructor 310 to send different content or assignments 510-1, 510-2, and 510-3 (hereinafter, collectively referred to as “assignments 510”) to different breakout groups 351 (cf. FIGS. 3A-3B). Launch tab 551 and don't launch tab 552 enable the user to control the sending of assignments 510 to the selected breakout rooms 351.

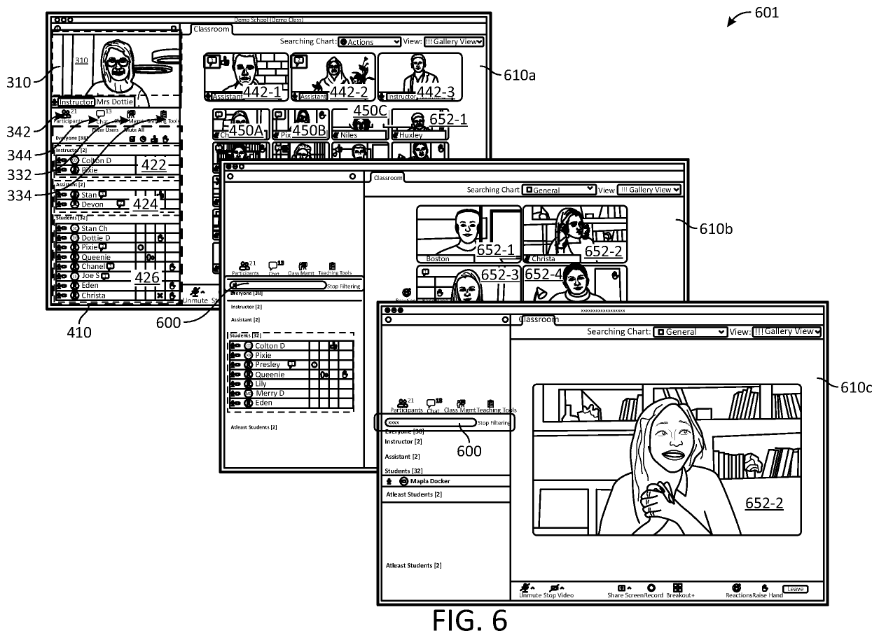

FIG. 6 illustrates a filtering feature 600 for users and video feeds in a participant tool 342 for a virtual classroom 601, according to some embodiments. A first screenshot 610a of virtual classroom 601 includes instructor 310, class management tool 332, teaching tool 334, participant tool 342, and chat tool 344 (cf. FIGS. 3A-3B). Screenshot 610a may also include participation list 410 with attributes for each of the instructors 422, teaching assistants 424, and students 426, teaching assistants 442 and auxiliary feeds 450 (cf. FIG. 4). Screenshots 610a and 610b may also include students 652-1, 652-2, 652-3 and 653-4 (hereinafter, collectively referred to as “students 652”).

Filtering feature 600 enables any user to search for a given participant in virtual classroom 601 (e.g., a specific student 652-2). Screenshot 610c illustrates the video feed for the filtered student (e.g., student 652-2). Feature 600 may be particularly useful for large classes. Users can type in a name and easily find a person and associated video feed in participation list 410 and on the video screen for virtual classroom 601.

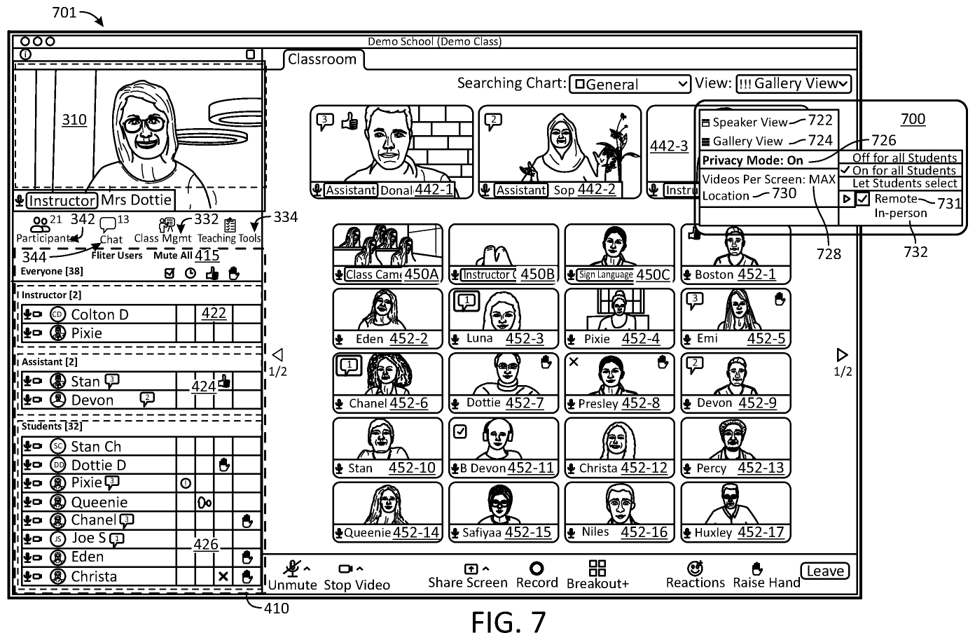

FIG. 7 illustrates a hybrid learning feature 700 for teaching tool 334 in a virtual classroom 701, according to some embodiments. Virtual classroom 701 includes instructor 310, class management tool 332, participant tool 342, and chat tool 344 (cf. FIGS. 3A-3B). Virtual classroom 701 may also include participation list 410 with attributes for each of the instructors 422, teaching assistant attributes 424, and student attributes 426, teaching assistants 442, students 452 and auxiliary feeds 450 (cf. FIG. 4).

Hybrid learning feature 700 includes a speaker view 722 and a gallery view 724. Instructor 310 may control virtual classroom 701 to: (1) stream everyone, (2) stream only people not in room, or (3) stream no one. Instructor 310 can lock audio for one student or breakout group using a privacy mode feature 726 (e.g., for a one-on-one conversation or a breakout group intervention). Students can select “Privacy Mode” 726 feature which lets their video feed only be visible for the instructor 310 and teaching assistants 442. Instructors can set it for the whole class. The user may also select a number of video feeds of other participants to show per screen with a tab 728. Users may select a number of videos to place in a screen of virtual classroom 701. In some embodiments, users can set if their location 730 is “remote” 731 (e.g., default configuration) or “in-person” 732.

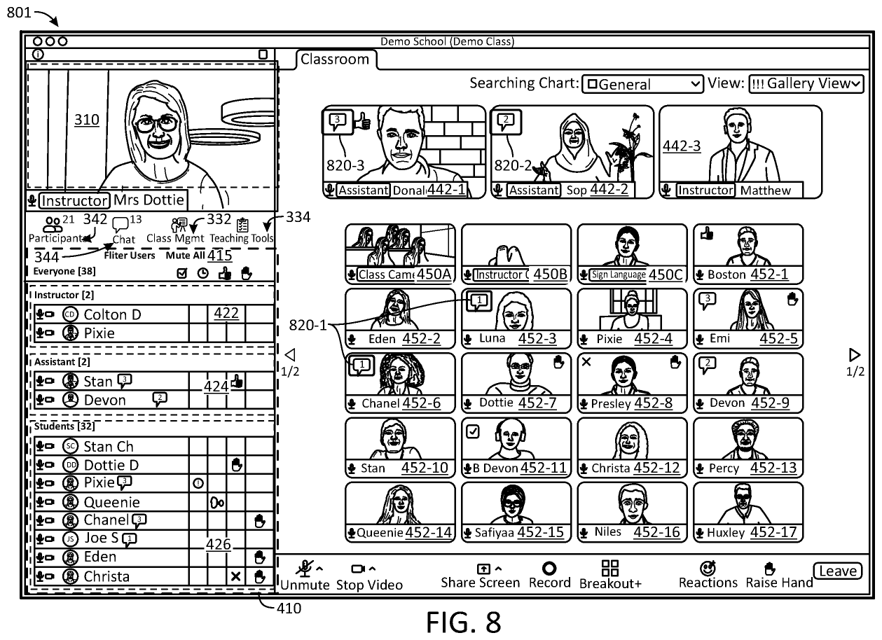

FIG. 8 illustrates bubble features 820-1, 820-2, and 820-3 (hereinafter, collectively referred to as “bubble features 820”) in a chat tool 344 for a virtual classroom 801, according to some embodiments. Virtual classroom 801 includes instructor 310, class management tool 332, participant tool 342, and chat tool 344 (cf. FIGS. 3A-3B). Virtual classroom 801 may also include participation list 410 with attributes for each of the instructors 422, teaching assistant attributes 424, and student attributes 426, teaching assistants 442, students 452 and auxiliary feeds 450 (cf. FIG. 4).

Bubble features 820 appear on the user's video feed and enable instructor 310 or students 452 to easily identify who is directly messaging them. In some embodiments, clicking a bubble opens the chat.

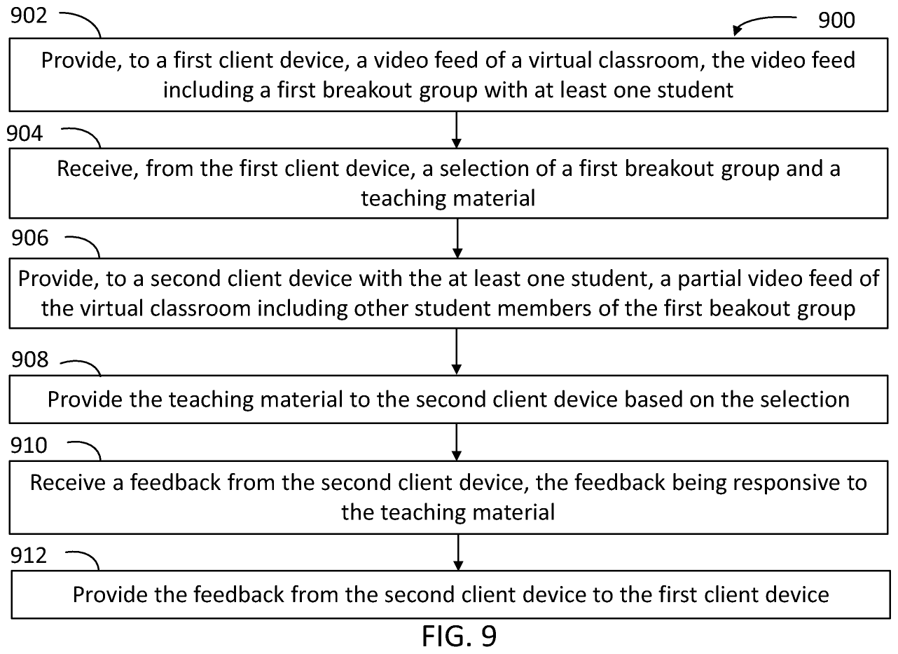

FIG. 9 is a flow chart illustrating steps in a method 900 for managing a virtual classroom, according to some embodiments. Method 900 may be performed at least partially by any one of a plurality of servers and client devices handled by instructors, teaching assistants, and students in a class (e.g., client devices 110, servers 130, instructor 310, teaching assistants 342, and students 352). For example, at least some of the steps in method 900 may be performed by one component in a system, including a mobile device running code for a browser and an application to access a virtual classroom hosted by a classroom engine (e.g., application 222, classroom engine 240, and virtual classrooms 201, 301, 401, 501, 601, 701, and 801). In some embodiments, the classroom engine may be coupled with an application layer, as disclosed herein (e.g., application layer 225) that hosts and handles the application for participants who may access the virtual classroom remotely. The classroom engine provides the virtual classroom with the support of a participant tool and a chat tool, as disclosed herein (e.g., participant tool 242 and chat tool 244). In addition, at least some steps in method 900 may include an instructor or teaching assistant accessing a course engine in a server as disclosed herein to manage a class with a class management tool and to prepare teaching and learning materials for the class with a teaching tool (e.g., course engine 230, class management tool 232, teaching tool 234). Accordingly, at least some of the steps in method 900 may be performed by a processor executing commands stored in a memory of one of the servers, or accessible by at least one of the servers. Further, in some embodiments, at least some of the steps in method 900 may be performed overlapping in time, almost simultaneously, or in a different order from the order illustrated in method 900. Moreover, a method consistent with some embodiments disclosed herein may include at least one, but not all, of the steps in method 900.

Step 902 includes providing, to a first client device, a video feed of a virtual classroom, the video feed including a first breakout group with at least one student. In some embodiments, step 902 includes providing, to a display in the first client device, a panel indicative of a student activity in the first breakout group, and updating the student activity in the panel based on the feedback. In some embodiments, the video feed further includes a classroom view, and step 902 includes providing to the first client device a video feed of at least one student that is not part of a breakout group in the classroom view. In some embodiments, step 902 includes adding a view from a class camera with at least one student in a real classroom in the video feed. In some embodiments, step 902 includes adding a view of an instructor camera illustrating instructor notes, in the video feed. In some embodiments, step 902 includes adding a video of a sign language translation of an instructor lecture, in the video feed. In some embodiments, step 902 includes sorting in a display of the first client device, an indicator of a student activity.

Step 904 includes receiving, from the first client device, a selection of a first breakout group and a teaching material.

Step 906 includes providing, to a second client device with the at least one student, a partial video feed of the virtual classroom including other student members of the first breakout group. In some embodiments, step 906 includes indicating, in the video feed for each of one or more participants in the virtual classroom, an indicator of a chat message directed to the second client device by the one or more participants. In some embodiments, step 906 includes receiving, from the second client device, a request for a privacy view from the at least one student, and removing a video capture of the at least one student from the video feed.

Step 908 includes providing the teaching material to the second client device based on the selection.

Step 910 includes receiving a feedback from the second client device, responsive to the teaching material.

Step 912 includes providing the feedback from the second client device to the first client device. In some embodiments, step 912 includes receiving, from a participant in the virtual classroom, a location feedback indicative of whether the first client device or the second client device is remotely connected to a server providing the video feed, and adjusting the video feed to the second client device based on the location feedback.

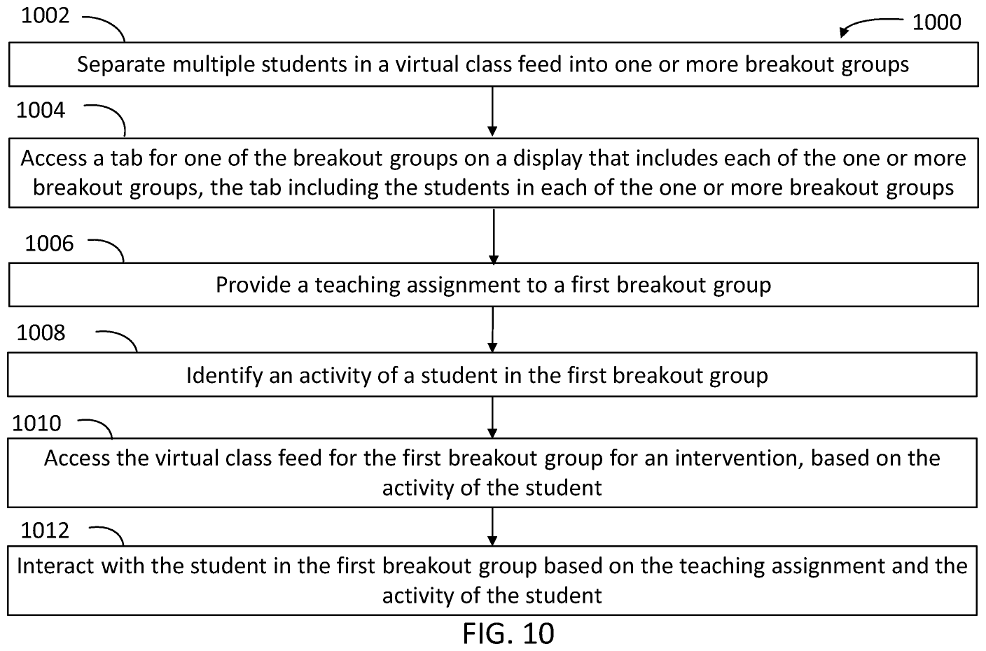

FIG. 10 is a flow chart illustrating steps in a method 1000 for managing a course for remote learning, according to some embodiments. Method 1000 may be performed at least partially by any one of a plurality of servers and client devices handled by instructors, teaching assistants, and students in a class (e.g., client devices 110, servers 130, instructor 310, teaching assistants 342, and students 352). For example, at least some of the steps in method 1000 may be performed by one component in a system, including a mobile device running code for a browser and an application to access a virtual classroom hosted by a classroom engine (e.g., application 222, classroom engine 240, and virtual classrooms 201, 301, 401, 501, 601, 701, and 801). In some embodiments, the classroom engine may be coupled with an application layer, as disclosed herein (e.g., application layer 225) that hosts and handles the application for participants who may access the virtual classroom remotely. The classroom engine provides the virtual classroom with the support of a participant tool and a chat tool, as disclosed herein (e.g., participant tool 242 and chat tool 244). In addition, at least some steps in method 1000 may include an instructor or teaching assistant accessing a course engine in a server as disclosed herein to manage a class with a class management tool and to prepare teaching and learning materials for the class with a teaching tool (e.g., course engine 230, class management tool 232, teaching tool 234). Accordingly, at least some of the steps in method 1000 may be performed by a processor executing commands stored in a memory of one of the servers, or accessible by at least one of the servers. Further, in some embodiments, at least some of the steps in method 1000 may be performed overlapping in time, almost simultaneously, or in a different order from the order illustrated in method 1000. Moreover, a method consistent with some embodiments disclosed herein may include at least one, but not all, of the steps in method 1000.

Step 1002 includes separating multiple students in a virtual class feed into one or more breakout groups. In some embodiments, step 1002 includes selecting a student from the one or more breakout groups with a filter and interfacing with the student via the virtual class feed. In some embodiments, step 1002 includes setting a privacy mode for the students in the virtual class feed. In some embodiments, step 1002 includes sorting the students in the virtual class feed according to an alphabetical listing or an action such as raising a hand, providing a feedback, or sending a chat message.

Step 1004 includes accessing a tab for one of the breakout groups on a display that includes each of the one or more breakout groups, the tab including the students in each of the one or more breakout groups.

Step 1006 includes providing a teaching assignment to a first breakout group.

Step 1008 includes identifying an activity of a student in the first breakout group. In some embodiments, step 1008 may include identifying an activity of a second student in a second breakout group.

Step 1010 includes accessing the virtual class feed for the first breakout group for an intervention, based on the activity of the student. In some embodiments, step 1010 includes accessing the virtual class feed for the second breakout group for an intervention, based on the activity of the second student.

Step 1012 includes interacting with the student in the first breakout group based on the teaching assignment and the activity of the student. In some embodiments, step 1012 includes providing a poll to the students in a second breakout group and interacting with the students in the second breakout group based on a result of the poll.

### Hardware Overview

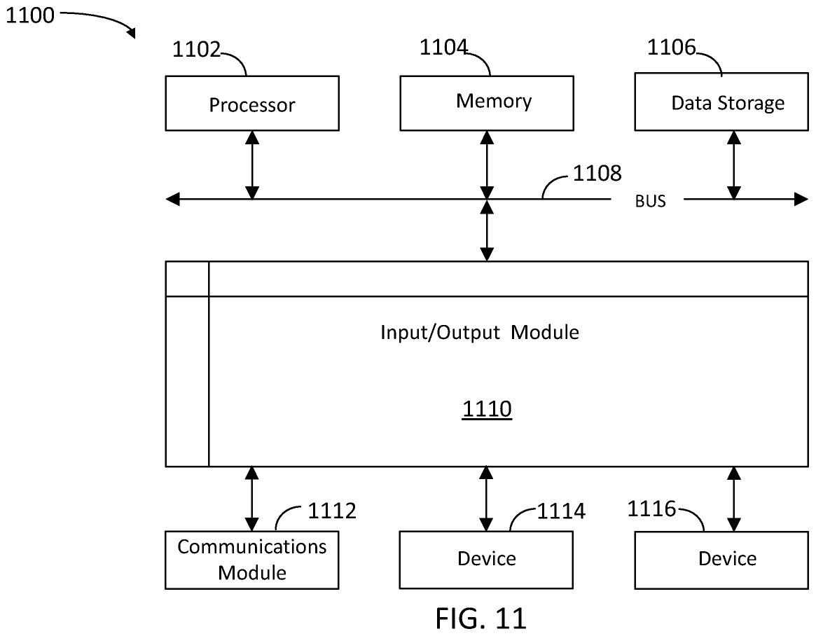

FIG. 11 is a block diagram illustrating an example computer system with which client devices 110, servers 130, and methods 900 and 1000 can be implemented. In certain aspects, the computer system 1100 may be implemented using hardware or a combination of software and hardware, either in a dedicated server, integrated into another entity, or distributed across multiple entities.

Computer system 1100 (e.g., client device 110 and server 130) includes a bus 1108 or other communication mechanism for communicating information, and a processor 1102 (e.g., processors 212) coupled with bus 1108 for processing information. By way of example, the computer system 1100 may be implemented with one or more processors 1102. Processor 1102 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1100 can include, in addition to hardware, code that creates an execution environment for the computer program in question, e.g., code that constitutes processor firmware, a protocol stack, a database management system, an operating system, or a combination of one or more of them stored in an included memory 1104 (e.g., memories 220), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 1108 for storing information and instructions to be executed by processor 1102. The processor 1102 and the memory 1104 can be supplemented by, or incorporated in, special purpose logic circuitry.

The instructions may be stored in the memory 1104 and implemented in one or more computer program products, e.g., one or more modules of computer program instructions encoded on a computer-readable medium for execution by, or to control the operation of, the computer system 1100, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 1104 may also be used for storing temporary variable or other intermediate information during execution of instructions to be executed by processor 1102.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 1100 further includes a data storage device 1106 such as a magnetic disk or optical disk, coupled to bus 1108 for storing information and instructions. Computer system 1100 may be coupled via input/output module 1110 to various devices. Input/output module 1110 can be any input/output module. Exemplary input/output modules 1110 include data ports such as USB ports. The input/output module 1110 is configured to connect to a communications module 1112. Exemplary communications modules 1112 (e.g., communications modules 218) include networking interface cards, such as Ethernet cards and modems. In certain aspects, input/output module 1110 is configured to connect to a plurality of devices, such as an input device 1114 (e.g., input device 214) and/or an output device 1116 (e.g., output device 216). Exemplary input devices 1114 include a keyboard and a pointing device (e.g., a mouse or a trackball) by which a user can provide input to the computer system 1100. Other kinds of input devices 1114 can be used to provide for interaction with a user as well, such as a tactile input device, visual input device, audio input device, or brain-computer interface device. For example, feedback provided to the user can be any form of sensory feedback (e.g., visual feedback, auditory feedback, or tactile feedback); and input from the user can be received in any form, including acoustic, speech, tactile, or brain wave input. Exemplary output devices 1116 include display devices, such as an LCD (liquid crystal display) monitor, for displaying information to the user.

According to one aspect of the present disclosure, the client device 110 and server 130 can be implemented using a computer system 1100 in response to processor 1102 executing one or more sequences of one or more instructions contained in memory 1104. Such instructions may be read into memory 1104 from another machine-readable medium, such as data storage device 1106. Execution of the sequences of instructions contained in main memory 1104 causes processor 1102 to perform the process steps described herein. One or more processors in a multi-processing arrangement may also be employed to execute the sequences of instructions contained in memory 1104. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back-end component (e.g., a data server), or that includes a middleware component (e.g., an application server), or that includes a front-end component (e.g., a client computer having a graphical user interface or a Web browser through which a user can interact with an implementation of the subject matter described in this specification), or any combination of one or more such back-end, middleware, or front-end components. The components of the system can be interconnected by any form or medium of digital data communication (e.g., a communication network). The communication network (e.g., network 150) can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, a tree or hierarchical network, or the like. The communications modules can be, for example, modems or Ethernet cards.

Computer system 1100 can include clients and servers. A client and server are generally remote from each other and typically interact through a communication network. The relationship of client and server arises by virtue of computer programs running on the respective computers and having a client-server relationship to each other. Computer system 1100 can be, for example and without limitation, a desktop computer, laptop computer, or tablet computer. Computer system 1100 can also be embedded in another device, for example and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 1102 for execution. Such a medium may take many forms, including, but not limited to, non-volatile media, volatile media, and transmission media. Non-volatile media include, for example, optical or magnetic disks, such as data storage device 1106. Volatile media include dynamic memory, such as memory 1104. Transmission media include coaxial cables, copper wire, and fiber optics, including the wires forming bus 1108. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially described as such, one or more features from a described combination can in some cases be excised from the combination, and the described combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the described subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately described subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed:

1. A computer-implemented method, comprising:
providing, to a first client device, a video feed of a virtual classroom, the video feed including a first breakout group with at least one student;
receiving, from the first client device, a selection of a first breakout group and a teaching material;
providing, to a second client device with the at least one student, a partial video feed of the virtual classroom including other student members of the first breakout group;
providing the teaching material to the second client device based on the selection;
receiving a feedback from the second client device, responsive to the teaching material; and
providing the feedback from the second client device to the first client device.

2. The computer-implemented method of claim 1, further comprising providing, to a display in the first client device, a panel indicative of a student activity in the first breakout group, and updating the student activity in the panel based on the feedback.

3. The computer-implemented method of claim 1, wherein the video feed further includes a classroom view, further providing to the first client device a video feed of at least one student that is not part of a breakout group in the classroom view.

4. The computer-implemented method of claim 1, wherein providing a video feed of a virtual classroom comprises including a view from a class camera with at least one student in a real classroom in the video feed.

5. The computer-implemented method of claim 1, wherein providing a video feed of a virtual classroom comprises including a view of an instructor camera illustrating an instructor notes, in the video feed.

6. The computer-implemented method of claim 1, wherein providing a video feed of a virtual classroom comprises including a video of a sign language translation of an instructor lecture, in the video feed.

7. The computer-implemented method of claim 1, wherein providing a video feed of a virtual classroom comprises sorting in a display of the first client device, an indicator of a student activity.

8. The computer-implemented method of claim 1, wherein providing a partial video feed of the virtual classroom comprises indicating, in the video feed for each of one or more participants in the virtual classroom, an indicator of a chat message directed to the second client device by the one or more participants.

9. The computer-implemented method of claim 1, further comprising receiving, from the second client device, a request for a privacy view from the at least one student, and removing a video capture of the at least one student from the video feed.

10. The computer-implemented method of claim 1, further comprising receiving, from a participant in the virtual classroom, an location feedback indicative of whether the first client device or the second client device is remotely connected to a server providing the video feed, and adjusting the video feed to the second client device based on the location feedback.

11. A system, comprising:
one or more processors; and
a memory storing instructions which, when executed by the one or more processors, cause the system to:
provide, to a first client device, a video feed of a virtual classroom, the video feed including a first breakout group with at least one student;
receive, from the first client device, a selection of a first breakout group and a teaching material;
provide, to a second client device with the at least one student, a partial video feed of the virtual classroom including other student members of the first breakout group;
provide the teaching material to the second client device;
receive a feedback from the second client device, responsive to the teaching material; and
provide the feedback from the second client device to the first client device.

12. The system of claim 11, wherein the one or more processors further execute instructions to provide, to a display in the first client device, a panel indicative of a student activity in the first breakout group, and to update the student activity in the panel based on the feedback.

13. The system of claim 11, wherein the video feed further includes a classroom view, and the one or more processors further execute instructions to provide, to the first client device, a video feed of at least one student that is not part of a breakout group in the classroom view.

14. The system of claim 11, wherein to provide a video feed of a virtual classroom the one or more processors execute instructions to include a view from a class camera with at least one student in a real classroom in the video feed.

15. The system of claim 11, wherein to provide a video feed of a virtual classroom the one or more processors execute instructions to include a view of an instructor camera illustrating an instructor notes, in the video feed.

16. A computer-implemented method, comprising:
separating multiple students in a virtual class feed into one or more breakout groups;
accessing a tab for one of the breakout groups on a display that includes each of the one or more breakout groups, the tab including the students in each of the one or more breakout groups;
providing a teaching assignment to a first breakout group;
identifying an activity of a student in the first breakout group;
accessing the virtual class feed for the first breakout group for an intervention, based on the activity of the student; and
interacting with the student in the first breakout group based on the teaching assignment and the activity of the student.

17. The computer-implemented method of claim 16, further comprising selecting a student from the one or more breakout groups with a filter and interfacing with the student via the virtual class feed.

18. The computer-implemented method of claim 16, further comprising setting a privacy mode for the students in the virtual class feed.

19. The computer-implemented method of claim 16, further comprising sorting the students in the virtual class feed according to an alphabetical listing or an action such as raising a hand, providing a feedback, or sending a chat message.

20. The computer-implemented method of claim 16, further comprising providing a poll to the students in a second breakout group and interacting with the students in the second breakout group based on a result of the poll.
